(19) United States
(12) Patent Application Publication
(10) Pub. No.: US 2025/0074790 A1
(43) Pub. Date: Mar. 6, 2025

(54) ZERO LIQUID DISCHARGE EUTECTIC FREEZE DESALINATION WITH INTERMEDIATE COLD LIQUID

(71) Applicant: The Board of Regents of the University of Oklahoma, Oklahoma City, OK (US)

(72) Inventors: Hamidreza Shabgard, Norman, OK (US); Ramkumar N. Parthasarathy, Norman, OK (US); Jie Cai, Norman, OK (US)

(73) Assignee: The Board of Regents of the University of Oklahoma, Oklahoma City, OK (US)

(21) Appl. No.: 18/948,202

(22) Filed: Nov. 14, 2024

Related U.S. Application Data
(63) Continuation-in-part of application No. 17/095,675, filed on Nov. 11, 2020, now Pat. No. 12,187,625.
(60) Provisional application No. 63/603,905, filed on Nov. 29, 2023.
(60) Provisional application No. 62/933,932, filed on Nov. 11, 2019.

(51) Int. Cl. C02F 1/22; C02F 1/38; C02F 1/52

(52) U.S. Cl. CPC C02F 1/22; C02F 1/385; C02F 2001/5218

(57) ABSTRACT

A method for desalinating a brine includes the use of a cooled intermediate-cold-liquid (ICL), which combines with the brine in a crystallization or freezing tank, where the brine and cooled ICL are contacted for a time sufficient to produce a slurry of ice, brine, and ICL. The method includes steps for separating the ICL, ice and brine, and melting the separated ice to form a volume of desalinated water. The method is significant in that it produces desalinated liquid water and solid salts. The combination of superior heat transfer with high quality purified water and competitive desalination economy makes the disclosed freeze desalination technology an attractive solution for desalination of highly concentrated brines produced in a variety of industries, including but not limited to the oil and gas industry and reject brine management.

### RELATED APPLICATIONS

This application is a continuation-in-part of U.S. patent application Ser. No. 17/095,675, filed on Nov. 11, 2020, which claims the benefit of U.S. Provisional Patent Application No. 62/933,932, filed on Nov. 11, 2019, and further claims the benefit of U.S. Provisional Patent Application No. 63/603,905, filed on Nov. 29, 2023, the disclosures of which are hereby incorporated by reference as if set forth in their entirety herein.

### STATEMENT OF GOVERNMENT FUNDING

This invention was made with government support under Contract Number DE-AR0001069 awarded by the U.S. Department of Energy. The government has certain rights in the invention.

### FIELD OF THE INVENTION

This invention generally relates to the treatment of highly concentrated brine and, more particularly, to freeze desalination systems and methods for treatment of highly concentrated brines.

### BACKGROUND

Fresh water resources are becoming increasingly scarce due to diminishing resources and increasing consumption. At the same time, wastewater management imposes a challenge in various municipal and industrial sectors. As an example, the oil and gas industry consumes large volumes of fresh water during the recovery of hydrocarbons while producing large volumes of wastewater that is contaminated with a variety of minerals, heavy metals, and organic compounds. For example, most produced water is a salt brine that is dominated by sodium chloride. Modern oil and gas extraction techniques, including hydraulic fracturing, produce particularly large volumes of contaminated wastewater. Management of the produced water presents a significant challenge to the industry due to the limitations of existing treatment technologies and the potential negative environmental impacts of releasing insufficiently treated water to the environment. Currently, produced wastewater from oil and gas operations is injected into deep disposal wells, which raises concerns over drinking water contamination and potential seismic implications. The increasing demand and decreasing availability of fresh water presents a significant concern to the economy and the environment.

The growing global demand for freshwater has resulted in an increasing interest in desalination technologies to treat wastewater. Various technologies have been developed for water desalination and purification over the past several decades. The commercially available desalination techniques can be grouped into two main categories: membrane-based desalination (reverse osmosis and forward osmosis) and thermal desalination (e.g., multi-stage flash and multi-effect desalination). Membrane-based desalination techniques, such as reverse osmosis (a form of pressurized filtration in which the filter is a semi-permeable membrane that allows water to pass through), are presently limited by significant specific energy consumption, high unit costs, and environmental impacts including greenhouse gas emissions and organism impingement through intakes.

Turning to thermal desalination, multi-stage flash came into practice in the early 1960s and became popular due to its reliability and simplicity. The most important disadvantage of multi-stage flash is the relatively higher energy consumption which renders multi-stage flash competitive only when energy costs are very low. The other major thermal desalination technology is multi-effect distillation which consists of a series of stages in which evaporation and condensation occur in a decreasing pressure (temperature) order. The heat of condensation of steam in each stage is recovered to generate more steam at a lower pressure and temperature. Compared to multi-stage flash, the significant increase in heat transfer area in the multi-stage distillation, in addition to the thermodynamic superiority, results in a very low temperature drop per stage/effect (1.5-2.5° C.). As such, multi-stage distillation systems are able to incorporate a large number of effects of 8-16 in typical large plants. The performance ratio is generally higher than the multi-stage flash systems. Unlike multi-stage flash, the multi-effect distillation process usually operates as a once-through system and the absence of recirculation of large brine masses significantly reduces pumping requirements.

All of the aforementioned desalination methods are prone to significant fouling and scaling at higher feed brine salinities. Traditional thermal and membrane-based desalination technologies are best suited for water sources with relatively low total dissolved solids (TDS), with typical salt concentrations less than 70,000 ppm. In fact, the majority of desalination plants are designed for treatment of seawater. As such, the application of the existing commercially available membrane-based and thermal desalination technologies to water sources with higher TDS concentrations will lead to operational problems such as fouling and corrosion as well as lower efficiencies.

In contrast to traditional thermal and membrane-based desalination techniques, freeze desalination processes are naturally well-suited for low-quality feed streams because pure ice (water) crystals can be produced even in highly concentrated brines. Freeze desalination, in brief, is a desalination technique that involves cooling saline water until it partially freezes. Fresh water is extracted in the form of ice, and the remaining unfrozen brine becomes more concentrated. The freeze desalination process encounters fewer issues related to scaling, fouling, and corrosion than traditional membrane-based and thermal desalination methods because freeze desalination operates at low temperatures. From an energy standpoint, the latent heat of fusion of water is almost one-seventh of its latent heat of evaporation, rendering the freezing process inherently less energy intensive than evaporation. Furthermore, freeze desalination systems do not require significant pretreatment of the feed, resulting in lower levels of chemicals discharged to the environment.

Currently, there are three major types of freeze desalination technology, namely, direct-contact, indirect-contact and vacuum freeze desalination. Each of these technologies has deficiencies which hinder their widespread use compared to thermal and membrane-based methods.

In direct contact systems, a liquid refrigerant is injected into the brine, and freezing occurs as the refrigerant absorbs heat from the brine upon vaporization. Direct contact freezing offers very large heat transfer coefficients, and enhanced heat transfer between the refrigerant and the saline water produces the benefit of a high ice production rate. However, the purified water contains excessive amounts of refrigerant that are hard to separate due to hydrate formation. The freezing process is also difficult to control, which degrades the quality of the treated water.

In indirect contact systems, a solid surface separates the refrigerant from the brine, thereby preventing the diffusion of the refrigerant into the purified water. This refrigerant-free water generally has a high quality because the relatively slow and controlled freezing process reduces the likelihood of brine entrapment between ice crystals. Indirect contact systems can be broadly classified into two categories: layer freeze desalination (e.g., layer growth freezing on stationary or rotating surfaces, dynamic layer growth) and suspension crystallization. Each of the above methods has its own deficiencies. Layer growth systems require large equipment volumes and complex moving mechanisms to resolve the slow crystallization rate and to facilitate ice separation from the cold surfaces. The major drawbacks of the dynamic layer growth systems are large system size and entrainment of the salts in the ice, resulting in low quality purified water. The suspension freeze systems suffer from lack of effective control of nucleation and complex system design. In general, the high desalination rates of indirect contact systems often correlate with low recovery ratios and require relatively high energy consumption, stemming from the reduced heat transfer rate between the refrigerant and the feed brine, as well as design complexities.

Another challenge shared by both direct and indirect freeze desalination methods is separating residual brine from the ice before melting it. If the residual brine dissolves in the melted ice, the salinity of the treated water will increase.

Turning to vacuum freeze desalination, these systems use the cooling effect of evaporating water under vacuum to create ice formation. In other words, evaporation and freezing occur simultaneously under vacuum. However, the compression of low pressure and low density vapor in the vacuum freeze systems requires a significant amount of energy that negatively impacts the economy of desalination. Moreover, in vacuum freeze systems diffusion of dissolved gases from the brine into the vapor usually leads to reduced water quality.

In view of the deficiencies in the current desalination and wastewater processing technologies, there is a significant need for a desalination technology capable of handling highly concentrated water with acceptable energy efficiency and cost-competitiveness.

### SUMMARY OF THE INVENTION

In one embodiment, the present invention includes a method for desalinating a feed brine, where the feed brine includes a salt dissolved in water. In this embodiment, the method begins with the steps of introducing the feed brine and a cooled intermediate-cold-liquid (ICL) to a crystallization tank, and contacting the feed brine with the ICL for a time sufficient to form a slurry of ice, brine, and ICL. The method continues with the steps of separating the ICL, ice and brine, and melting the separated ice to form a volume of desalinated liquid water.

In another embodiment, the present invention provides a water treatment system for removing salt from a feed brine, where the water treatment system includes a crystallization tank configured to receive the feed brine and a source of cooled intermediate-cold-liquid (ICL) connected to the crystallization tank. The cooled ICL and feed brine are mixed within the crystallization tank to form a slurry of ice, brine, and ICL, after which a primary separator is configured to separate the slurry of ice, brine, and ICL. The water treatment system also includes a melt tank configured to melt the separated ice to form a volume of desalinated liquid water.

In yet another embodiment, the present invention includes a method for desalinating a feed brine using a single-stage freezing process, where the feed brine includes a salt dissolved in water. In this embodiment, the method begins with the steps of providing a source of cooled intermediate-cold-liquid (ICL), introducing the feed brine and the cooled ICL to a crystallization tank, and contacting the feed brine with the ICL for a time sufficient to form a slurry of ice, brine, and ICL. The method continues with the steps of separating the ICL, ice and brine, and returning the separated ICL to the source of cooled ICL tank. The method concludes with the steps of passing the separated brine to the crystallization tank, and melting the separated ice to form desalinated water.

In yet another aspect, the present invention provides a method for desalinating a feed brine using a two-stage freezing process, wherein the feed brine includes a salt dissolved in water. In this embodiment, the method begins with the steps of providing a source of cooled intermediate-cold-liquid (ICL), introducing the feed brine and the cooled ICL to a first stage freezing tank, and contacting the feed brine with cooled ICL for a time sufficient to form a first slurry of ice, brine, and ICL within the first stage freezing tank. The method continues with the steps of separating the ICL, ice and brine of the first slurry of ice, brine and ICL in a first wash column, moving the separated ice to a first stage melting tank to form a first volume of desalinated liquid water, and separating the ICL from the brine in a first stage ICL-brine separator. The method concludes with the steps of moving the separated brine to a second stage freezing tank, and contacting the separated brine with cooled ICL for a time sufficient to form a second slurry of ice, brine and ICL within the second stage freezing tank.

In yet another embodiment, the present invention provides a method for desalinating a feed brine using a freezing process, wherein the feed brine includes a salt dissolved in water. In this embodiment, the method includes the steps of adding the feed brine to a crystallization tank, adding a cooled intermediate-cold-liquid (ICL) to the crystallization tank, and holding the feed brine in the crystallization tank with the cooled ICL for a time sufficient to form a slurry of ice, ICL, and brine within the crystallization tank. The method continues with the steps of separating the ice from the ICL and brine and melting the separated ice to produce desalinated liquid water. The method concludes with the steps of separating solid salt from the brine, and returning any liquid brine and ICL to the crystallization tank.

### BRIEF DESCRIPTION OF DRAWINGS

FIG. 1 is a schematic diagram of a water treatment process carried out in accordance with an exemplary embodiment.

FIG. 2 is a schematic diagram of a water treatment process carried out in accordance with an alternate embodiment.

FIG. 3 is a schematic diagram of a water treatment process carried out in accordance with an alternate two-stage freezing embodiment.

FIG. 4 is a schematic diagram of a water treatment process carried out in accordance with an alternative embodiment.

FIG. 5 is a process flowchart for a eutectic freeze desalination method using an intermediate-cold-liquid.

FIG. 6 depicts the inlet and outlet streams of a main crystallization tank in accordance with an exemplary embodiment.

FIG. 7 depicts theoretical (Rₜₕ) and experimental (Rₑₓ) recovery ratios and corresponding TDS of the treated water (TDS_{tw}) for cooling temperature of −17° C. and various feed brine salinities (TDS_{fb}) in accordance with exemplary embodiments, where the error bars represent the overall uncertainty of the measurements.

FIG. 8 depicts the experimentally determined desalination rate (n) and recovery ratio (Rₑₓ) for a cooling temperature of −17° C. and multiple feed brine salinities (TDS_{fb}) in accordance with exemplary embodiments, where the error bars represent the overall uncertainty of the measurements.

FIG. 9 depicts theoretical (Rₜₕ) and experimental (Rₑₓ) recovery ratios and corresponding TDS of the treated water (TDS_{tw}) for feed brine TDS of 70,000 ppm and various cooling temperatures in accordance with exemplary embodiments, where the error bars represent the overall uncertainty of the measurements.

FIG. 10 depicts the experimental recovery ratio (Rₑₓ) and corresponding TDS of the treated water (TDS_{tw}) for feed brine TDS_{fb} of 70,000 ppm and a cooling temperature of −17° C. in accordance with exemplary embodiments, where the error bars represent the overall uncertainty of the measurements.

### DETAILED DESCRIPTION

To address the shortcomings in the prior art, the various embodiments of the present disclosure provide a novel zero-liquid discharge eutectic-freeze desalination technology that is particularly well suited for the treatment of highly concentrated brines produced in the industrial and oil and gas sectors. In particular, the disclosed system takes advantage of the excellent heat transfer performance of direct contact freezing systems without being affected by dissolution of the refrigerant in the purified water. In various embodiments of the present disclosure, cooling fluid and brine are directly mixed. However, unlike conventional direct freeze desalination where the refrigerant fluid of the refrigeration cycle is mixed with the brine, the present system utilizes an intermediate-cold-liquid which circulates between a refrigeration unit and a desalination unit. The combination of superior heat transfer with high quality purified water and competitive desalination economy makes the disclosed freeze desalination technology an attractive solution for desalination of highly concentrated brines produced in a variety of industries, including but not limited to the oil and gas industry and reject brine management.

Before further describing various embodiments of the present disclosure in more detail by way of exemplary description, examples, and results, it is to be understood that the embodiments of the present disclosure are not limited in structure and application to the details as set forth in the following description. The embodiments of the present disclosure are capable of being practiced or carried out in various ways not explicitly described herein. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complication of the description. While the present disclosure has been described in terms of particular embodiments, it will be apparent to those of skill in the art that variations may be applied to the apparatus and/or methods and in the steps or in the sequence of steps of the methods described herein without departing from the concept, spirit, and scope of the inventive concepts as described herein. All such similar substitutes and modifications apparent to those having ordinary skill in the art are deemed to be within the spirit and scope of the inventive concepts as disclosed herein.

All patents, published patent applications, and non-patent publications referenced or mentioned in any portion of the present specification are indicative of the level of skill of those skilled in the art to which the present disclosure pertains, and are hereby expressly incorporated by reference in their entirety to the same extent as if the contents of each individual patent or publication was specifically and individually incorporated herein. More particularly, the present disclosure expressly incorporates by reference the entirety of U.S. Provisional Patent Application No. 62/933,932, filed on Nov. 11, 2019, entitled, “Zero Liquid Discharge Eutectic Freeze Desalination with Intermediate Cold Liquid,” and the entirety of U.S. patent application Ser. No. 17/095,675, filed on Nov. 11, 2020, also entitled, “Zero Liquid Discharge Eutectic Freeze Desalination with Intermediate Cold Liquid.”

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

Abbreviations that may be used herein include those listed in Table 1.

TABLE 1
Abbreviations.

| | |
|---|---|
| c | specific heat capacity (kJ/kg · K) |
| EDX | energy dispersive X-ray |
| hₛₗ | latent heat of fusion (kJ/kg) |
| ICL | intermediate-cold-liquid |
| [symbol] | mass flow rate (kg/s) |
| PDMS | polydimethylsiloxane |
| [symbol] | heat transfer rate (kJ/s) |
| R | $recovery ratio , R = \frac{{\dot{m}}_{ice}}{{\dot{m}}_{fb}}$ |
| S | $salinity ( g / kg ) , S = \frac{{m}_{s}}{{m}_{b}}$ |
| T | temperature (° C.) |
| TDS | total dissolved solids (ppm) |
| t | time (minutes) |
| lngp | density (kg/m3) |
| η | $desalination rate , η = \frac{{m}_{s , cb}}{{m}_{s , fb}}$ |
| avg | average |
| b | brine |
| cb | concentrated brine |
| cent | centrifugation |
| ex | experimental |
| fb | feed brine |
| frz | freezing |
| s | salt |
| th | theoretical |
| tw | treated water |

As utilized in accordance with the apparatus, methods and compositions of the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the terms “at least one” or “plurality” will be understood to include one as well as any quantity more than one, including but not limited to, 2, 3, 4, 5, 6, 7, 8, 9, 10, 15, 20, 30, 40, 50, 100, or any integer inclusive therein, and/or any range described herein. The terms “at least one” or “plurality” may extend up to 100 or 1000 or more, depending on the term to which it is attached; in addition, the quantities of 100/1000 are not to be considered limiting, as higher limits may also produce satisfactory results. In addition, the use of the term “at least one of x, y and z” will be understood to include x alone, y alone, and z alone, as well as any combination of x, y and z.

Where the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

As used in this specification and claims, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “a, b, c, or combinations thereof” is intended to include at least one of: a, b, c, ab, ac, bc, or abc, and if order is important in a particular context, also ba, ca, cb, cba, bca, acb, bac, or cab. Continuing with this example, expressly included are combinations that contain repeats of one or more item or term, such as bb, aaa, aab, bbc, aaabcccc, cbbaaa, cababb, and so forth. The skilled artisan will understand that typically there is no limit on the number of items or terms in any combination, unless otherwise apparent from the context.

Throughout this application, the terms “about” and “approximately” are used to indicate that a value includes the inherent variation of error for the composition, the method used to administer the composition, or the variation that exists among the objects, or study subjects. As used herein the qualifiers “about” or “approximately” are intended to include not only the exact value, amount, degree, orientation, or other qualified characteristic or value, but are intended to include some slight variations due to measuring error, manufacturing tolerances, stress exerted on various parts or components, observer error, wear and tear, and combinations thereof, for example. The terms “about” or “approximately”, where used herein when referring to a measurable value such as an amount, a temporal duration, thickness, width, length, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art. As used herein, the term “substantially” means that the subsequently described event or circumstance completely occurs or that the subsequently described event or circumstance occurs to a great extent or degree. For example, the term “substantially” means that the subsequently described event or circumstance occurs at least 75% of the time, at least 80% of the time, at least 90% of the time, at least 95% of the time, or at least 98% of the time.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-30 therefore includes 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30, as well as sub-ranges within the greater range, e.g., for 1-30, sub-ranges include but are not limited to 1-10, 2-15, 2-25, 3-30, 10-20, and 20-30. Reference to a range of 1-50 therefore includes 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30, etc., up to and including 50. Reference to a series of ranges includes ranges which combine the values of the boundaries of different ranges within the series. Thus, to illustrate reference to a series of ranges, for example, a range of 1-1,000 includes, but is not limited to, 1-10, 2-15, 2-25, 3-30, 10-20, 20-30, 30-40, 40-50, 50-60, 60-75, 75-100, 100-150, 150-200, 200-250, 250-300, 300-400, 400-500, 500-750, 750-1,000, and includes ranges of 1-20, 10-50, 50-100, 100-500, and 500-1,000. The range 1 mm to 10 m therefore refers to and includes all values or ranges of values, and fractions of the values and integers within said range, including for example, but not limited to, 5 mm to 9 m, 10 mm to 5 m, 10 mm to 7.5 m, 7.5 mm to 8 m, 20 mm to 6 m, 15 mm to 1 m, 31 mm to 800 cm, 50 mm to 500 mm, 4 mm to 2.8 m, and 10 cm to 150 cm. Any two values within the range of 1 mm to 10 m therefore can be used to set lower and upper boundaries of a range in accordance with the embodiments of the present disclosure.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

The inventive concepts of the present disclosure will be more readily understood by reference to the following examples and embodiments, which are included merely for purposes of illustration of certain aspects and embodiments thereof, and are not intended to be limitations of the disclosure in any way whatsoever. Those skilled in the art will promptly recognize appropriate variations of the apparatus, compositions, components, procedures and method shown below.

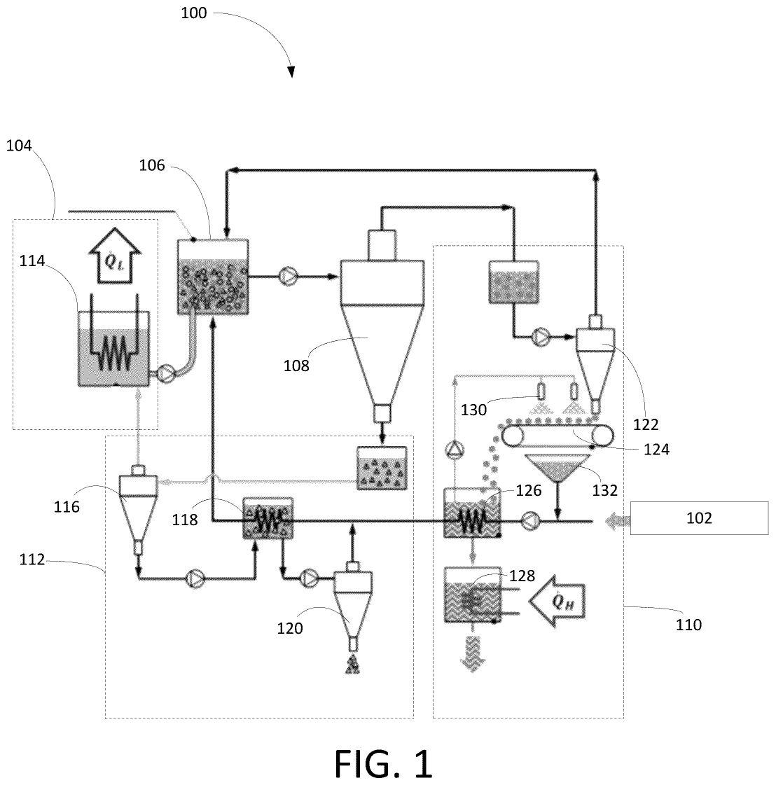

Turning to FIG. 1, shown therein is a schematic diagram illustrating an inventive water treatment process 200 carried out in accordance with an exemplary, non-limiting, embodiment of a water treatment system 100. Generally, the treatment process 200 makes use of a water-immiscible intermediate-cold-liquid (ICL) to freeze water, which is then separated from the ice, precipitated salts and remaining liquid brine. The ice can be melted to produce purified water, while the ICL is separated from brine and recirculated and cooled through a refrigeration cycle. The system can be operated in both “zero-liquid” output mode, in which the only liquid produced by the system is purified, desalinated water, or partial freeze mode, where a fraction of the water in the input brine is recovered by freezing. In zero-liquid output operation, salt and other contaminants are removed from the system as solids for facilitated disposal or downstream processing.

The treatment system 100 generally includes an untreated brine feed source 102, a refrigerated ICL source 104, a main crystallization tank 106, a primary separator 108, a water-brine separation module 110, and an ICL-brine separation module 112. The ICL source 104 includes an ICL tank 114 that contains a suitable, refrigerated ICL. Suitable ICLs include silicone-based fluids that are immiscible with water and present low health, safety and environmental risks. Some main classes of stable coolants that are liquids at a room temperature include aromatics, silicate-ester (SE), aliphatics, silicones, and fluorinated liquids (e.g., perfluorinated compounds (PFC), perfluoroelastomers (PFE), hydrofluoroethers (HFE), fluorinated ketones (FK)). In some applications, segregated HFEs available from the 3M Company as Novec 7000-series fluids can be used as the ICL.

The ICL is cooled within the ICL tank 114 with an external refrigeration system or heat exchanger. In some applications, the ICL tank 114 is cooled using solar-driven absorption ammonia refrigeration, which permits refrigeration of the ICL without connection to an established electrical grid. In exemplary embodiments, the ICL is cooled to about −30° C. within the ICL tank 114.

The refrigerated ICL is injected into the main crystallization tank 106 together with brine streams from the untreated brine feed source 102 and the brine recovered from the water-brine separation module 110 and the ICL-brine separation module 112. In exemplary embodiments, the untreated brine is precooled to a temperature of about 0° C. before it is injected into the main crystallization tank 106, as described below.

In the main crystallization tank 106, cold ICL absorbs thermal energy from the brine, while maintaining immiscibility with the brine. The average temperature within the main crystallization tank 106 is maintained at about −24° C. by adjusting the flow rate of the cold ICL relative to the untreated input brine. In some embodiments, the ICL flow rate is an order of magnitude greater than the brine flow rates entering the main crystallization tank 106. In some applications, the main crystallization tank 106 includes a paddle, stirrer or other agitation system that encourages good mixing between the ICL and the brine. In other applications, the main crystallization tank 106 is configured such that the injection of the ICL and brines produces sufficient mixing without additional agitation. Nozzles and manifolds may be used to more equally distribute the ICL and brine within the main crystallization tank 106.

As the injected ICL comes in contact with the brine, both salt and ice crystals form. The ice-ICL-salt-brine mixture is pumped or otherwise moved from the main crystallization tank 106 to the primary separator 108. In some embodiments, the primary separator 108 is a cyclonic separator that induces a rotation of the ice-ICL-salt-brine mixture. Alternatively, hydraulic or mechanical wash columns can be employed to separate the ice from the slurry. As shown in FIG. 1, when ICL has a greater density than the brine, the heavier salt-ICL slurry exits from the bottom of the primary separator 108 and the lighter ice-brine slurry leaves from the top of the primary separator 108. Within the salt-ICL slurry, the brine component may be present completely or partially as hydrohalite crystals. The lighter ice-brine slurry is a mixture of purified water ice crystals carried in a brine solution.

The cooled, separated salt-ICL slurry is provided by pumping or other means to the ICL-brine separation module 112. The ICL-brine separation module 112 includes an ICL-brine separator 116, a hydrohalite heat exchanger 118, and a salt-brine separator 120. Although the exemplary embodiments are not so limited, in FIG. 1 the ICL-brine separator 116 and the salt-brine separator 120 are each cyclonic separators that mechanically separate feed components based on density. In the ICL-salt separator 116, the ICL is separated from the hydrohalite and provided directly or indirectly to the ICL tank 114 for refrigeration. The immiscibility and lower density of the ICL than the hydrohalite promotes good separation from the hydrohalite.

The hydrohalite is then provided to the hydrohalite heat exchanger 118, where it absorbs heat from the feed brine to the main crystallization tank 106. This precools the feed brine to the main crystallization tank 106, while warming the hydrohalite. It will be noted that the hydrohalite heat exchanger 118 is a closed system in which the feed brine to the main crystallization tank 106 is not in direct contact with the hydrohalite. The hydrohalite heat exchanger 118 can use immersed coils, shell and tube, or any other type of heat exchanger that maintains the separation of the hot and cool fluids while permitting the transfer of heat between the fluids. Upon receiving heat, the hydrohalite dissociates into a mixture of pure salt and saturated brine.

From the hydrohalite heat exchanger 118, the salt-brine slurry is passed to the salt-brine separator 120. In exemplary embodiments, the salt-brine separator 120 is a cyclonic separator in which the heavier solid salt particles are separated from the lighter liquid brine. The liquid brine is directed into the feed brine to the main crystallization tank 106. The solid salt particles are discharged as a solid product for disposal or downstream processing. Although the solid particles are expected to be primary sodium chloride solids, it will be appreciated that the solid particles may also include other solid minerals and contaminants.

Turning to the ice-brine separation module 110, the ice-brine slurry from the primary separator 108 is provided by pumping or other means to an ice-brine separator 122. In exemplary embodiments, the ice-brine separator 122 is a cyclonic separator in which the lighter solid ice particles are separated from the heavier liquid brine. The liquid brine is recirculated as feed brine to the main crystallization tank 106. The solid ice crystals are melted to provide purified water.

In the embodiment depicted in FIG. 1, the ice crystals are discharged from the ice-brine separator 122 onto a conveyor belt 124, which discharges the ice crystals into a first melting tank 126. The first melting tank 126 is configured as a heat exchanger that precools brine from the untreated brine feed source 102. The warm untreated brine melts at least a portion of the ice crystals to produce purified liquid water. A portion of the purified liquid water can be provided to a wash array 130 that is configured to disperse purified liquid water over the ice crystals on the conveyor belt 124. Alternatively, ICL at temperatures below 0° C. can be used to wash the ice without melting it. Also, the condenser compartment of the refrigeration system can be placed in the ice melting tank. This arrangement provides the required heat for melting the ice and also lowers the condenser temperature, thereby improving the coefficient of performance of the refrigeration system. The purified wash water or the ICL used for washing removes residual brine from the exterior of the ice crystals. The wastewater from the wash array 130 and conveyor belt 124 is captured by a catch basin 132 and directed into the brine feed line. The optional wash array 130 ensures a higher degree of purity of the ice crystals in the first melting tank 126. Purified, desalinated liquid water is produced from the melting tank 126.

It will be appreciated that the first melting tank 126 and the second melting tank is configured as a heat exchanger. The heat exchanger 126 can be configured as immersed coils, shell and tube, or any other type of heat exchanger that maintain the separation of the hot and cool fluids while permitting the transfer of heat between the fluids. In some embodiments, the liquid water and ice from the first melting tank 126 is provided to a second melting tank 128, where an external heat source is used to raise the temperature of the water to above the melting point. For example, the hot fluid used in the second melting tank 128 can be captured from the compression or condensing stages of the refrigeration cycle used to cool the ICL tank 114.

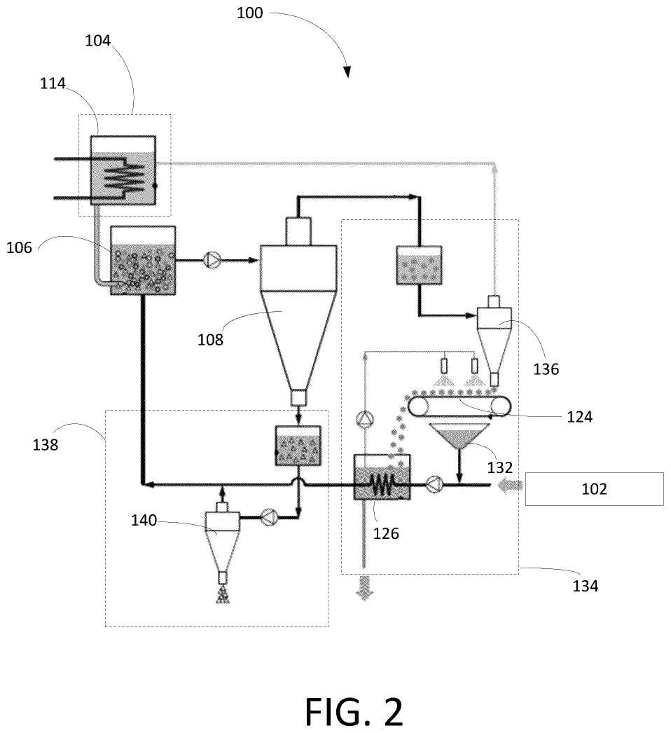

Turning to FIG. 2, shown therein is an alternate embodiment of the water treatment system 100. Depending on the selected ICL and the characteristics of the wastewater brine, the ice-ICL-salt-brine mixture may separate within the primary separator 108 into an ice-ICL slurry and a salt-brine slurry. In this configuration, the ice-ICL slurry is provided to an ice-ICL separation module 134 that includes an ice-ICL separator 136 in addition to the conveyor belt 124, wash array 130 and first melting tank 126. The ice-ICL separator 136 separates (through cyclonic or other mechanical separation mechanism) the heavier ice crystals from the lighter ICL liquid. The ICL liquid is pumped back to the ICL tank 114, while the ice crystals are deposited on the conveyor belt 124 to be washed with purified water from the first melting tank 126 or ICL at temperatures below 0° C. The washed solution is captured by the catch basin 132 and added to the feed brine line.

The salt-brine slurry produced by the primary separator 108 is passed to a salt-brine separation module 138 that includes a salt-brine separator 140. The salt brine separator 140 can be configured as a cyclonic separator that separates the lighter brine fluids from the heavier salt crystals. The lighter brine fluids are passed to the brine feed line while the solid salt crystals are discharged for disposal or downstream processing.

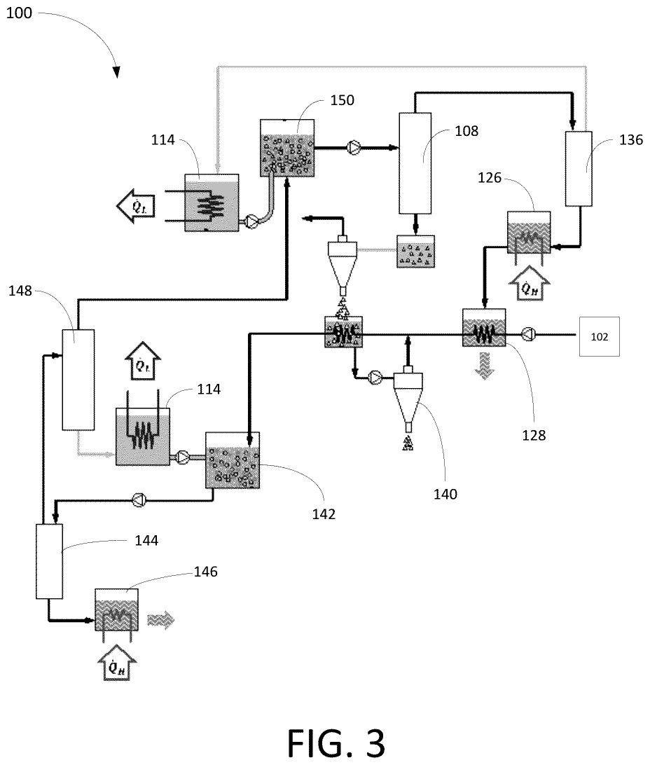

Turning to FIG. 3, shown therein is an alternative embodiment in which the freezing process is accomplished in two stages. Each stage is driven by a separate refrigeration system. The rationale for developing the two-stage freeze system is to breakdown the cooling load into two parts: a relatively high temperature freezing and a relatively low temperature freezing. By extracting the ice from the input brine at a relatively higher temperature, the refrigeration system driving the first stage freezing process can operate between a smaller temperature gap between the evaporator and condenser. This dramatically improves the energy efficiency of the refrigeration process due to increased Coefficient of Performance (COP) of the first stage refrigeration system. Overall energy savings up to 30% can be achieved compared to the single-stage freeze system.

In the first stage of freezing, the input brine is cooled to temperatures within a range from about −5° C. to about −20° C. in a first stage freezing tank 142 depending on the brine composition. In general, higher levels of total dissolved solids in the brine will require lower freezing temperatures. During this process, only ice crystals are formed and salt-hydrate formation is negligible. The ice-ICL-brine slurry from the first stage freezing tank 142 is introduced into a first wash column 144, where the solid ice is separated from the liquid ICL-brine mixture. The washed ice is carried to a first stage melting tank 146, where it is melted and recovered as fresh water. The cold energy of the ice in the first stage melting tank 146 can be recovered for cooling the condenser of the refrigeration system. The ICL-brine mixture discharged from the first wash column 144 is carried to a first stage ICL-brine separator 148, where the ICL and brine are separated by density and discharged through separate outlets. The separated ICL is recirculated through the refrigeration system and directed back to the first stage freezing tank 142.

The output brine from the first stage ICL-brine separator 148 is more concentrated than the input brine because a portion of the water has already been removed. The concentrated brine is introduced to the second stage freezing tank 150 for the second stage of freezing. In the second stage freezing tank 150, the temperature is further decreased to temperatures within a range from about −24° C. to −35° C. At these temperatures, both ice crystals and salt-hydrates are formed. Depending on the cooling temperature in the second stage freezing tank 150, the output from the second stage freezing tank 150 may be composed primarily, or entirely, of frozen solids such that all the impurities are discharged in solid phase, or where the output consists of only a small stream of highly concentrated liquid discharge.

The ice, salt-hydrates and ICL from the second stage freezing tank 150 are separated in the same manner explained above with regard to the single stage systems depicted in FIGS. 1-2, depending on the composition of the streams leaving the primary separator 108. As depicted in FIG. 3, the salt-brine-ICL slurry from the second stage freezing tank 150 is delivered to the primary separator 108. In this embodiment, an ice-ICL slurry is discharged from the top of the primary separator 108 and provided to the ice-ICL separation module 134 as depicted in the embodiment FIG. 2. The ice-ICL separation module 134 may include the ice-ICL separator 136, which fees the first melting tank 126 and optional second melting tank 128. The ice-ICL separator 136 separates (through cyclonic or other mechanical separation mechanism) the heavier ice crystals from the lighter ICL liquid. The ICL liquid is pumped back to the ICL tank 114. In the variation depicted in FIG. 3, the ice crystals sent directly to the first melting tank 126 without the use of a conveyor belt. It will be appreciated that the conveyor belt 124, wash array 130 and catch basin 132 can also be incorporated into the embodiment depicted in FIG. 3.

The salt-brine slurry produced by the primary separator 108 is passed to the salt-brine separation module 138, which includes the salt-brine separator 140. The salt brine separator 140 can be configured as a cyclonic separator that separates the lighter brine fluids from the heavier salt crystals. The lighter brine fluids are passed to the brine feed line back to the second stage freezing tank 150, while the solid salt crystals are discharged for disposal or downstream processing. Although the output from the primary separator 108 depicted in FIG. 3 follows the basic processing path depicted in FIG. 2, it will be appreciated that in some applications, the output from the primary separator 108 follows the processing steps depicted in FIG. 1 such that that an ice-brine slurry is discharged to a water brine separation module 110 and the ICL-brine mixture is directed to an ICL-brine separation module 112.

The two-stage freeze process is particularly advantageous for relatively lower brine concentrations (TDS<200,000 ppm). Above 200,000 ppm, there may be smaller differences between the energy efficiency of the single-stage and two-stage designs, mainly because no significant freezing occurs at temperatures above −20° C. for such high concentration brines.

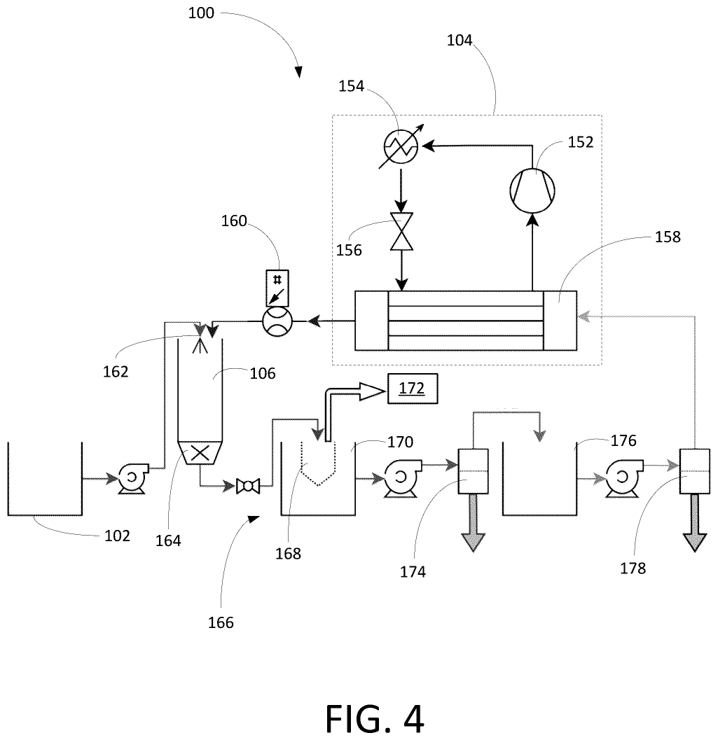

Turning to FIG. 4, shown therein is an alternative embodiment of a water treatment system 100. As depicted, the refrigerated ICL source 104 includes a compressor 152, a condenser 154, an expansion valve 156, and a heat exchanger 158. The heat exchanger 158 can use immersed coils, shell and tube, or any other type of heat exchanger that maintains the separation of the hot and cool fluids while permitting the transfer of heat between the fluids. In one embodiment, the heat exchanger 158 is an evaporator heat exchanger, more particularly a horizontal shell-and-tube heat exchanger within which refrigerant flows in the tube side and the ICL flows in the shell side in a counterflow arrangement.

The cold ICL circulates from the heat exchanger 158 to the top of the main crystallization tank 106 at a constant flow rate and temperature. The mass flow rate of the ICL is optionally measured by a mass flow meter 160 installed downstream of the heat exchanger 158. A brine stream is also pumped from the untreated brine feed source 102, injected from the top of the main crystallization tank 106, and mixed therein with the cold ICL. In one embodiment, a nozzle 162 is used to distribute the brine more equally within the main crystallization tank 106 as it is injected into the cold ICL.

As the injected brine contacts the ICL, ice crystals form inside the main crystallization tank 106, and the concentration of unfrozen brine increases because salt is repelled from the ice crystals. To avoid ice agglomeration and clogging, an ice grinder 164 (e.g., a rotary grinder) may be positioned at the bottom of the main crystallization tank 106 to crush the chunks of ice. This integrated ice crushing technique reduces brine entrapment and enhances the desalination rate. The optional ice grinder 164 also improves the mixing and heat transfer between brine droplets and the ICL by creating a swirling motion inside the main crystallization tank 106.

The ice crystals, unfrozen concentrated brine, and ICL exit the main crystallization tank 106 (e.g., through the ice grinder 164) and are transferred as a slurry to a primary separator 166. The primary separator 166 includes an ice-liquid separation filter bag 168 disposed within a settling tank 170. As the slurry passes through the ice-liquid separation filter bag 168, ice is separated from the liquid ICL-brine mixture and remains in the ice-liquid separation filter bag 168. The separated ice contains small amounts of concentrated brine and ICL and is referred to herein as “wet ice”. Wet ice results because, as the brine stream freezes partially inside the main crystallization tank 106, some brine adheres to the surface of the ice crystals or is trapped inside them. It is necessary to separate the residual brine and ICL from the wet ice to achieve low salinity treated water. Thus, the wet ice is transferred from the ice-liquid separation filter bag 168 to a centrifuge 172 to remove residual ICL and brine. In one embodiment, the centrifuge 172 is a refrigerated spin dryer.

Turning back to the primary separator 166, the liquid ICL-brine mixture that passes through the ice-liquid separation filter bag 168 is collected in the settling tank 170. This ICL-brine mixture is then pumped from the settling tank 170 to a first oil-water separation filter 174, which traps brine while allowing the dewatered ICL to pass through to an ICL tank 176. Once collected, the separated brine is gradually discharged through a discharge valve at the bottom of the first oil-water separation filter 174. The dewatered ICL, on the other hand, is recirculated from the ICL tank 176 back to the heat exchanger 158. To assure complete ICL-brine separation, a second oil-water separation filter 178 is optionally positioned between the ICL tank 176 and the heat exchanger 158, and any separated brine is discharged through a discharge valve at the bottom of the second oil-water separation filter 178.

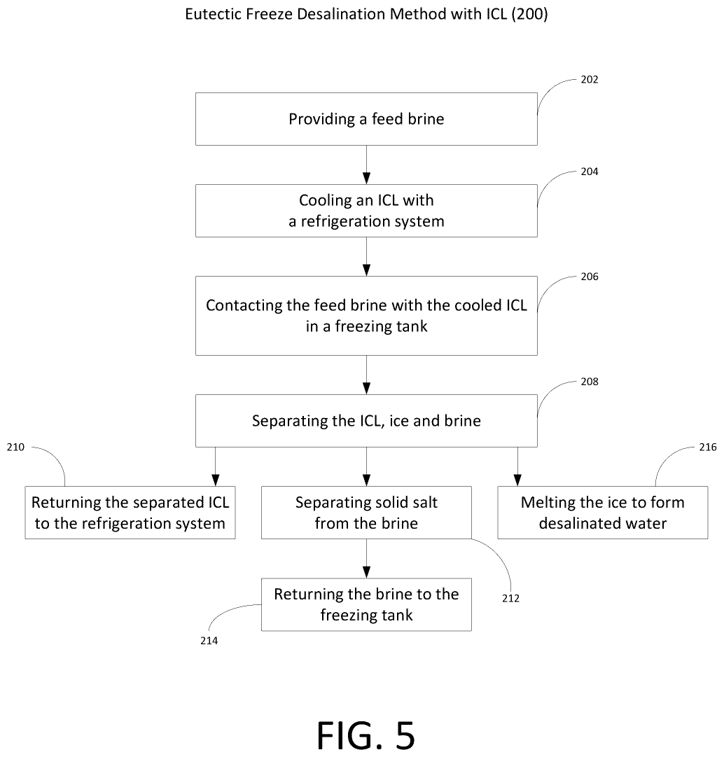

Turning to FIG. 5, shown therein is a process flow diagram for a freeze desalination method 200. The method 200 presents a general description of the processes that can be practiced using the systems depicted in FIGS. 1-3. It will be appreciated that the method 200 presents an overview of the desalination methods and many of the individual steps have been omitted from the diagram presented in FIG. 5.

Beginning at step 202, the feed brine 102 is provided to the water treatment system 100. At step 204, the intermediate-cold-liquid (ICL) is cooled to provide the refrigerated ICL source 104. At step 206, the feed brine 102 is contacted with the refrigerated ICL in a freezing or crystallization tank 106 for a time sufficient and under appropriate conditions to form ice crystals within the tank. Next, at step 208, the ice crystals are separated from the ICL and brine. In certain applications, the interaction between the brine and the ICL may have formed hydrohalites, which are also separated from the ice crystals.

At step 210, the ICL is separated from the other constituent components and returned to the refrigerated ICL source 104. The ICL can be separated from the other components through an ICL-brine separation module 112 or an ice-ICL separation module 134. At step 212, the solid salt crystals are separated from the brine. The salt can be separated from the brine with the salt-brine separator 120, 140. The solid salt can be discarded or used in downstream processes. At step 214, the remaining brine is returned for further processing in the main crystallization tank 106 (in a single stage process), or to the first stage freezing tank 142 (in a two stage process).

At step 216, the separated ice crystals a melted to form desalinated liquid water. The melting process can take place through use of the first melting tank 126 alone, or in combination with the second melting tank 128, wash array 130 and catch basin 132. It will be appreciated that in certain embodiments, the separated ice crystals can simply be transferred to a storage container or facility to be held at freezing temperatures, or at temperatures that allow the ice to melt over time to form desalinated water.

Thus, the embodiments of the present disclosure are well adapted to carry out the objects and attain the ends and advantages mentioned above as well as those inherent therein. While the inventive system and method have been described and illustrated herein by reference to particular non-limiting embodiments in relation to the drawings attached thereto, various changes and further modifications, apart from those shown or suggested herein, may be made therein by those of ordinary skill in the art, without departing from the spirit of the inventive concepts.

### EXAMPLES

Certain embodiments of the present disclosure will now be discussed in terms of several specific, non-limiting, examples. The examples described below will serve to illustrate the general practice of the present disclosure, it being understood that the particulars shown are merely exemplary for purposes of illustrative discussion of particular embodiments of the present disclosure only and are not intended to be limiting of the claims of the present disclosure.

For the below Examples, the outlet temperature of the main crystallization tank was always higher than the threshold temperature for formation of salt-hydrates. Therefore, salt-hydrates did not form, and the only solid substance in the system was ice.

For the below Examples, the mass fraction of the generated ice upon cooling was determined theoretically using an energy balance applied to the main crystallization tank. The following assumptions were considered: (i) the mixture in the main crystallization tank is well mixed and all components (namely, ice, unfrozen concentrated brine, and ICL) leave the main crystallization tank at the same temperature, (ii) the specific heat and density of the ICL are constant, and (iii) the salt is pure sodium chloride.

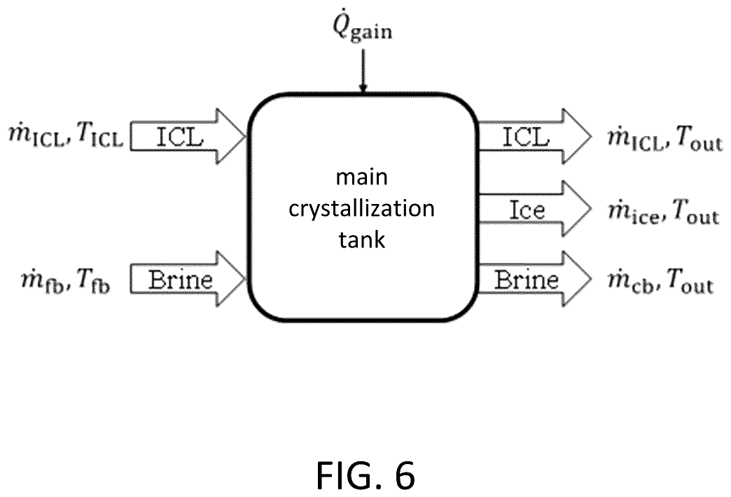

FIG. 6 depicts the input streams to the main crystallization tank (feed brine and cold ICL) and the output streams (ice, unfrozen concentrated brine, and ICL). The energy balance for the main crystallization tank is shown by Equation 1:

$${\dot{m}}_{ICL} {c}_{ICL} ( {T}_{out} - {T}_{ICL} ) = {\dot{m}}_{fb} {c}_{avg} ( {T}_{fb} - {T}_{out} ) + {\dot{m}}_{ice} {h}_{sl} + {\dot{Q}}_{gain} \qquad ( 1 )$$

where [symbol] _{ICL}, [symbol] _{fb}, and [symbol] _{ice} are the mass flow rates of ICL, feed brine, and generated ice, respectively; c_{ICL} and c_{avg} are the specific heat of the ICL, and the mass-averaged specific heat of the ice-brine mixture, respectively; hₛₗ is the latent heat of fusion of ice; T_{ICL}, T_{fb}, and Tₒᵤₜ are the temperature of the inlet ICL, the feed brine, and the outlet mixture, respectively; and [symbol] _{gain} is the heat gain from the ambient to the main crystallization tank due to imperfect insulation.

The mass-averaged specific heat of the ice-brine mixture is defined by Equation 2:

$${c}_{avg} = \frac{{\dot{m}}_{fb} {c}_{fb} + {\dot{m}}_{ice} {c}_{ice} + ( {\dot{m}}_{fb} - {\dot{m}}_{ice} ) {c}_{cb}}{2 {\dot{m}}_{fb}} \qquad ( 2 )$$

where c_{fb}, c_{ice}, and c_{cb} are the specific heat of the feed brine, produced ice, and concentrated brine, respectively.

The recovery ratio is defined as the mass flow rate of the produced ice to that of the feed brine, as shown in Equation 3:

$$R = \frac{{\dot{m}}_{ice}}{{\dot{m}}_{fb}} \qquad ( 3 )$$

Equations 1 and 2 can be rewritten using the recovery ratio as, respectively, Equations 4 and 5:

$${\dot{m}}_{ICL} {c}_{ICL} ( {T}_{out} - {T}_{ICL} ) = {\dot{m}}_{fb} [ {c}_{avg} ( {T}_{fb} - {T}_{out} ) + {Rh}_{sl} ] + {\dot{Q}}_{gain} \qquad ( 4 )$$

$${c}_{avg} = \frac{1}{2} [ {c}_{fb} + R {c}_{ice} + ( 1 - R ) {c}_{cb} ] \qquad ( 5 )$$

As a result of crystallization, the concentration of the unfrozen brine increases gradually through the main crystallization tank. As such, the thermophysical properties of the concentrated brine, including density, specific heat, latent heat of fusion, and freezing temperature, vary from the inlet to the outlet. The variations of these properties as a function of the brine salinity can be described by the equations presented in Table 3, where S denotes the salinity in grams of salts per kilogram of the brine, S=mₛ/m_{b} (g/kg). It is noted that these properties are derived for aqueous sodium chloride, however, since sodium chloride constitutes about 96% of the salt used in the Examples, these equations can be adopted with acceptable accuracy.

TABLE 3
Thermophysical properties of aqueous sodium chloride as a function of
salinity S (g/kg)

| Property | Equation |
|---|---|
| density (kg/m³) | ρ_{b} = S + 997 |
| specific heat capacity (kJ)/kg · K) | c_{b} = −0.0007232 S + 4.178 |
| latent heat of fusion (kJ/kg) | hₛₗ = −0.0003 S² − 0.074 S + 333 |
| freezing temperature (° C.) | T_{frz} = −0.0002 S² − 0.043 S |

The efficiency of freeze desalination is often characterized by the desalination rate, defined as the mass of salt in the rejected unfrozen concentrated brine to the mass of salt in the feed brine, as shown in Equation 6:

$$η = \frac{{m}_{s , cb}}{{m}_{s , fb}} = 1 - R ( \frac{{S}_{ice}}{{S}_{fb}} ) \qquad ( 6 )$$

where m_{s,cb} and m_{s,fb} are the mass of salt in the unfrozen concentrated brine and feed brine, and S_{ice} and S_{fb} are the salinities of the melted produced ice and feed brine, respectively.

Since the TDS was measured instead of salinity in the Examples, the desalination rate should be rewritten in terms of TDS. For a solution in which all the dissolved solids are salts, salinity and TDS are related by S_{b}=TDS_{b}/P_{b}. Because salts constituted about 96% of the dissolved mass in the Examples, the same conversion between salinity and TDS was applied. The desalination rate in terms of TDS can be written according to Equation 7:

$$η = 1 - R ( \frac{{ρ}_{fb}}{{ρ}_{ice}} ) ( \frac{{TDS}_{ice}}{{TDS}_{fb}} ) \qquad ( 7 )$$

Using the first equation in Table 3, the density of the brine can be expressed in terms of its TDS as ρ_{b}=498.5+\sqrt{498.5²+TDS_{b}}. Substituting this expression into Equation 7, the desalination rate at any recovery ratio can be obtained from the measured TDS values of the ice and feed brine. The outlet temperature of the main crystallization tank corresponds to the freezing temperature of the concentrated brine at the outlet, which in turn is a function of the salinity of the concentrated brine, S_{cb}. The salinity of the concentrated brine can be obtained as a function of the feed brine salinity, desalination rate, and recovery ratio, as shown in Equation 8:

$${S}_{cb} = η \frac{{S}_{fb}}{1 - R} \qquad ( 8 )$$

The outlet temperature (in ° C.) as a function of the salinity of the concentrated brine (in g of salt per kg of brine) can be obtained using the fourth equation in Table 3.

Equations 6-8 and those shown in Table 3 are based on salinity. The heat gain during the freezing process for the Examples was determined experimentally. To do so, the ICL was circulated through the system without brine injection at the same flow rate and temperature as the system with brine injection. After the steady state was reached, the temperature difference of the ICL across the main crystallization tank was measured and was used to calculate the heat gain, according to Equation 9:

$${\dot{Q}}_{gain} = {\dot{m}}_{ICL} {c}_{ICL} ( {T}_{ICL , out} - {T}_{ICL} ) \qquad ( 9 )$$

where T_{ICL,out} is the ICL temperature exiting the main crystallization tank without brine injection. The temperature rise of the ICL was measured to be about 1° C. for an ICL flow rate of 5 kg/min.

Having the heat gain determined, for any given T_{ICL}, \dot{m}_{ICL}, T_{fb}, \dot{m}_{fb}, and S_{fb}, the recovery ratio, R, the outlet temperature, Tₒᵤₜ, and the salinity of the concentrated brine, S_{cb}, can be calculated from Equations 4, 5, and 8 and those presented in Table 3, as a function of desalination rate (n). The desalination rate is obtained from the measurement of the treated water TDS after the centrifugation process for each experiment individually.

The experimental uncertainties were assessed by considering random (precision) error, the least count of instruments, and their respective accuracies. To address random error, each experiment was conducted three times, and the average value of the pertinent parameter was used for presentation and calculations. The measuring devices, i.e., the scale, flowmeter, and TDS meter, have least counts of 0.01 g, 0.0001 kg/s, and 100 ppm, respectively. The accuracies of these instruments are ±1%, ±0.1%, and ±1% of the reading, respectively. Experimental results had uncertainties ranging from 6% to 10% for TDS, 3% to 6% for R, and 0.1% to 2% for n.

### Example 1

An experimental set up was fabricated to investigate the effect of feed brine salinity on the recovery ratio and quality of produced ice.

The ICL used for Example 1 was PDMS (Polydimethylsiloxane) silicone fluid, which is non-toxic and immiscible with water. The ICL demonstrated a low freezing temperature (−70° C.), low viscosity at low temperatures (3 cSt at −25° C.), and a low vapor pressure at room temperature (0.13 kPa at 25° C.) compared to alternative immiscible cooling liquids such as hydrofluoroethers.

The ICL was cooled by a refrigerated ICL source operating with R-404A refrigerant and a three-phase reciprocating compressor (Copelametic HFC-404A) with nominal power of 2.44 kW at a saturated evaporating temperature of −31.7° C. The condenser of the refrigerated ICL source used a 4.5 m copper tube with an inner diameter of 0.011 m, which was formed into a coil and submerged in a water tank. The heat exchanger of the refrigerated ICL source was a horizontal shell-and-tube heat exchanger, with the shell and the tubes made of steel and copper, respectively, and the outer surface of the heat exchanger insulated by a layer of insulation foam with a thickness of 3 cm. The refrigerant and the ICL flowed in the tube side and shell side of the heat exchanger, respectively, in a counterflow arrangement. The cooling capacity of the refrigerated ICL source was controlled by modulating the electronic expansion valve opening through a LabVIEW graphical user interface to achieve the desired cooling temperature. The refrigerant flow rate and temperature at the inlet and outlet of the heat exchanger and condenser were recorded during the operation.

The experimentally determined recovery ratios and treated water TDS at four feed brine salinities of 15,000 ppm, 35,000 ppm, 70,000 ppm, and 100,000 ppm and a cooling temperature of −17° C. were compared. Brine was prepared at the various salinities by adding regular table salt to tap water (tap water TDS≈250 ppm). The elemental composition of the table salt was analyzed using energy dispersive X-ray (EDX) method and the results are presented in Table 2. As evident, sodium chloride constitutes nearly 96% of the salt mass. Salt was added to water gradually and the solution was thoroughly mixed. The TDS of the resulting feed brine was measured using a Hanna Instruments HI2300 TDS meter and additional salt was added until the desired TDS was achieved.

TABLE 2
The EDX analysis of the salt.

| Component | Weight percentage |
|---|---|
| C | 2.6% |
| O | 1.4% |
| Na | 37.4% |
| Cl | 58.5% |
| Mo | 0.1% |

The main crystallization tank was made from a 1-meter long polycarbonate cylindrical tube with an inner diameter of 10 cm and a wall thickness of 0.5 cm. A second polycarbonate cylindrical tube with a height of 70 cm and an inner diameter of 12 cm was placed around the upper section of the inner cylinder and the annular space between the two cylinders was vacuumed. The double wall design around the upper section of the main crystallization tank prevented condensation on the outer surface of the main crystallization tank, thereby improving visual access to the freezing process and decreasing the heat gain.

As the ICL was pumped toward the main crystallization tank, the mass flow rate of the ICL was measured by an Emerson Micro Motion Coriolis mass flow meter with an accuracy of ±0.1% of the reading, installed downstream of the heat exchanger. The brine was pumped from the untreated brine feed source using a stainless-steel corrosion-resistant centrifugal pump and was injected into the cold ICL through a nozzle as small droplets in the range of 50 μm to 100 μm. The small size of brine particles improves the heat transfer by increasing the contact surface area between the brine and the cold ICL. By spraying the feed brine into the cold ICL, the temperature of the brine droplets decreased until the freezing temperature corresponding to the TDS of the feed brine is reached. The ICL and feed brine flow rates were 5 kg/min and 0.13 kg/min, respectively, and the feed brine inlet temperature was 20° C.

After ice crystals formed in the main crystallization tank, the slurry was routed to an ice-liquid separator, where wet ice was collected and transferred to a centrifuge. The wet ice was centrifuged by a spin-dryer spinning at 3200 rpm for 12 minutes. Most of the liquid was rejected by centrifugation and the drained ice contained significantly less liquid. Finally, the drained ice was collected and melted, and its TDS was measured.

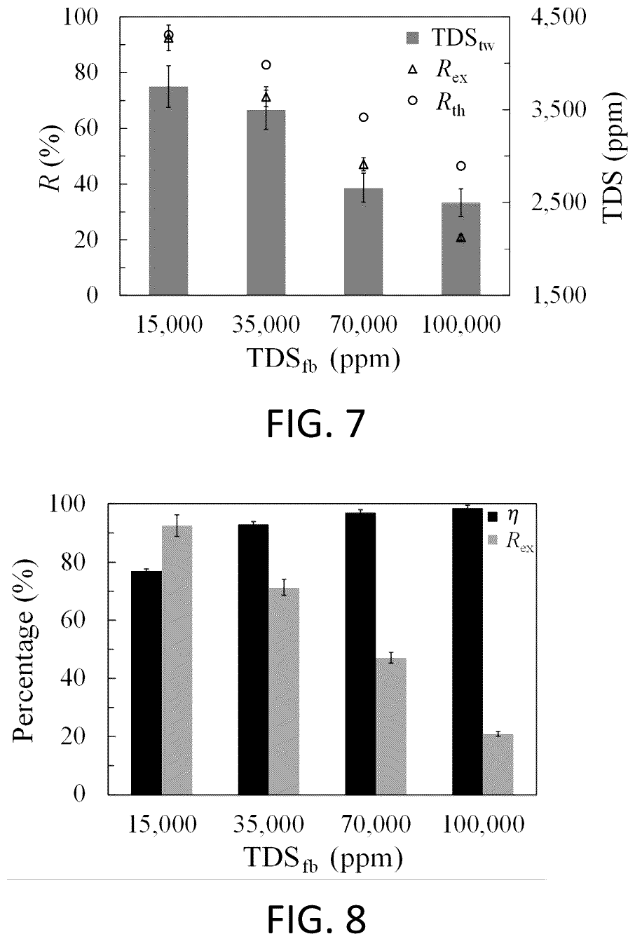

FIG. 7 shows the experimental and theoretical recovery ratios and treated water TDS for the multiple feed brine salinities (15,000 ppm, 35,000 ppm, 70,000 ppm, and 100,000 ppm). As depicted, the recovery ratio decreased by increasing the feed brine TDS, but the salinity of the produced ice was lower for higher feed brine TDS. This result can be attributed to the rate of freezing. At a fixed cooling temperature and feed brine flow rate, lowering the feed brine salinity results in greater amount of ice generation during the same period of time, which corresponds to a higher rate of ice crystallization. The faster crystallization rates increase the likelihood of concentrated brine entrapment within the ice crystals. These small pockets of entrapped brine are hard to remove by centrifugal draining, and if left inside the ice increase the TDS of the treated water upon melting of the ice.

Both experimentally and theoretically determined recovery ratios decrease by increasing the feed brine TDS. It can be observed in FIG. 7 that, at lower feed TDS levels, the experimental results for recovery ratio are closer to the theoretical ones, but their deviation grows as the feed salinity increases. The poor agreement at higher feed brine TDS levels can be attributed to the greater amount of unintended ice melting during transport and centrifugation of ice. For higher brine TDS, the entrapped brine within the ice also has higher TDS. The ice adjacent to these high salinity brine pockets is more likely to melt during the centrifugation.

FIG. 8 shows the experimentally determined desalination rates, n, and the associated recovery ratios, Rₑₓ, for various feed salinities and a cooling temperature of −17° C. It is evident that for a fixed cooling temperature increasing the feed brine salinity improves the desalination rate and decreases the recovery ratio.

In summary, the experimental findings demonstrated that at a fixed cooling temperature, the ice generation was greater for feed brine with smaller salinities. However, the salinity of the treated water was lower for feed brines with greater salinities. This can also be explained by the faster crystallization at lower feed brine TDS.

### Example 2

The experimental set-up from Example 1 was used to investigate the effect of cooling temperature on the recovery ratio and quality of the produced ice in this Example 2. The temperature effect was studied at a fixed feed brine TDS of 70,000 ppm and an ICL mass flow rate of 5 kg/min. The feed brine flow rate and temperature were also fixed at 0.13 kg/min and 20° C., respectively. Four cooling temperatures (the temperature at the outlet of the main crystallization tank) of −10° C., −14° C., −17° C., and −20° C. were tested. These temperatures were achieved by controlling the inlet ICL temperatures through adjusting the cooling power provided by the refrigerant. The steady ICL flow and brine injections were established, and the cooling power was adjusted until the desired temperature at the outlet of the main crystallization tank was achieved. The collected ice was centrifuged by the spin-dryer for 12 minutes to drain the liquids. The spin-dryer was placed inside a freezer to retain the ice temperature below the melting point during centrifugation. The freezer temperature was maintained at around −10° C. The drained ice was recovered from the spin-dryer and its mass and TDS were measured after melting.

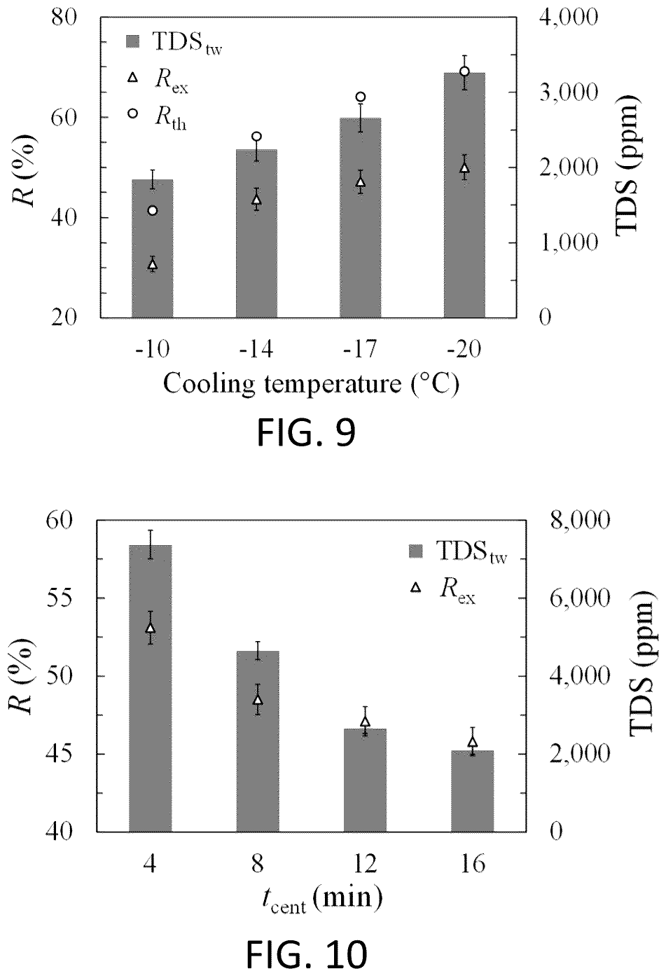

The effect of the cooling temperature on the recovery ratio and TDS of the drained ice after melting (treated water) is shown in FIG. 9. As depicted, lowering the cooling temperature results in higher recovery ratios. The TDS of the treated water (TDS_{tw}) was 3300, 2700, 2200, and 1800 ppm for the cooling temperatures of −20° C., −17° C., −14° C., and −10° C., respectively. The lower TDS of the treated water at relatively higher cooling temperatures can be attributed to the slower ice crystallization, which provides more time for the ice crystals to repel the brine. Conversely, at lower cooling temperatures, crystallization occurs faster, resulting in a greater amount of brine entrapment within the ice. The inverse relationship between the TDS of the treated water in freeze desalination systems and the temperature of the freezing process has been reported by several investigators. Another reason for the lower TDS of the treated water at relatively high cooling temperatures might be the lower mass ratio of ice to unfrozen brine. The lower ice formation results in a smaller rise in the salinity of the unfrozen brine. Thus, the unfrozen brine entrapped in the ice also has a lower TDS. It can be concluded that there is a tradeoff between the recovery ratio and TDS of the treated water.

FIG. 9 also shows the theoretically determined recovery ratios at various cooling temperatures. As evident, the theoretical results overpredict the recovery ratios compared to the experimental data. This is potentially due to partial melting and loss of ice inside the filter bag and during transportation to the spin-dryer device and centrifugation.

In summary, the experimental results showed that at constant feed brine salinity, as the cooling temperature decreased the recovery ratio increased. However, the TDS of the treated water was higher at lower cooling temperatures. This can be ascribed to the faster crystallization rates at lower cooling temperatures, which results in less time for salt rejection and higher salt entrapment within the ice crystals.

### Example 3

The experimental set-up from Example 1 was used to investigate the effect of the duration of the centrifugal brine removal on the recovery ratio and quality of the produced ice in this Example 3.

Various centrifugation durations (t_{cent}) from 4 to 16 minutes were investigated. Table 4 presents experimental recovery ratio (Rₑₓ) and TDS of the treated water (TDS_{tw}) and desalination rate (η) for a feed brine TDS of 70,000 ppm and cooling temperature of −17° C. for various centrifugation durations (t_{cent}). Further increase of the centrifugation time did not affect the TDS significantly.

TABLE 4

| t_{cent} (minutes) | Rₑₓ (%) | TDS_{tw} (ppm) | η (%) |
|---|---|---|---|
| 4 | 53.1 | 7,370 | 93.4 |
| 8 | 48.5 | 4,650 | 96.3 |
| 12 | 47.1 | 2,660 | 97.9 |
| 16 | 45.8 | 2,100 | 98.6 |

FIG. 10 shows the variations of the recovery ratio and treated water TDS with the centrifugation duration. As evident, increasing the centrifugation time results in smaller TDS_{tw} and recovery ratios. Increasing the brine removal from the ice by a longer centrifugation time has two simultaneous effects: on one hand, it diminishes the amount of unfrozen brine within the ice, and as such decreases the total mass of the ice recovered from the spin-dryer which translates into a smaller recovery ratio. On the other hand, the TDS of the treated water improves because there is less unfrozen brine in the recovered ice. The desalination rate for centrifugation times of 4, 8, 12, and 16 minutes are about 93%, 96%, 98%, and 99%, respectively. Notably, the desalination rate improves by about 3% by increasing the centrifugation time from 4 minutes to 8 minutes, while increasing it from 12 minutes to 16 minutes improves the desalination rate by about 1%. The lessened enhancement in the desalination rate can be ascribed to the difficulty in brine rejection at later times when the ice becomes “drier”, and the remaining brine becomes harder to expel. Consequently, for centrifugation times longer than ˜16 minutes, the brine rejection becomes negligible and only slight variations in recovery ratio and TDS of the treated water occur.

In summary, longer centrifugation times resulted in better removal of unfrozen concentrated brine from the ice, leading to lower TDS of the treated water. Centrifugation times greater than ˜16 minutes had negligible effect on recovery ratio and salinity of the treated water.

It is claimed:

1. A method for desalinating a feed brine, wherein the feed brine includes a salt dissolved in water, the method comprising the steps of:
introducing the feed brine and cooled intermediate-cold-liquid (ICL) to a crystallization tank;
contacting the feed brine with the cooled ICL for a time sufficient to form a slurry of ice, brine, and ICL;
separating the ice, brine, and ICL; and
melting the separated ice to form a volume of desalinated liquid water.

2. The method of claim 1, further comprising a step of providing the feed brine with a salinity ranging from 15,000 ppm to 100,000 ppm.

3. The method of claim 1, wherein the step of contacting the feed brine with the cooled ICL further comprises contacting the feed brine with the cooled ICL for a time and at a temperature sufficient to form the slurry of ice, brine, and ICL within the crystallization tank.

4. The method of claim 3, wherein the temperature sufficient to form the slurry ranges from −35° C. to −10° C.

5. The method of claim 1, further comprising a step of crushing the ice of the slurry using an ice grinder.

6. The method of claim 1, wherein the step of separating the ice, brine, and ICL comprises the steps of:
using a primary separator to separate the slurry of ice, brine, and ICL into an ice-brine slurry and an ICL-brine slurry;
separating the ice and a first volume of the brine from the ice-brine slurry; and
separating the ICL and a second volume of the brine from the ICL-brine slurry.

7. The method of claim 1, wherein the step of separating the ice, brine, and ICL comprises the steps of:
using a primary separator to separate the slurry of ice, brine, and ICL into an ice-ICL slurry and the brine; and
separating the ice and the ICL from the ice-ICL slurry.

8. The method of claim 1, wherein the step of separating the slurry further comprises the steps of:
using a primary separator to separate the slurry of ice, brine, and ICL into wet ice and an ICL-brine mixture;
centrifuging the wet ice to obtain the ice and a first volume of the brine; and
separating the ICL and a second volume of the brine from the ICL-brine mixture.

9. The method of claim 8, wherein the step of centrifuging the wet ice is performed for a centrifuging time ranging from 4 minutes to 16 minutes.

10. The method of claim 1, further comprising a step of recirculating the separated ICL to the crystallization tank.

11. The method of claim 1, further comprising the step of recirculating the separated brine to the crystallization tank.

12. The method of claim 1, further comprising the steps of:
moving the separated brine into a salt-brine separator;
separating the salt from the brine in the salt-brine separator; and
removing solid salt from the salt-brine separator.

13. The method of claim 1, wherein the step of contacting the feed brine with the cooled ICL further comprises contacting the feed brine with the cooled ICL for a time sufficient to form a slurry of ice, brine, ICL, and salt, wherein the step of separating the ice, brine, and ICL slurry further comprises separating the ice, brine, ICL, and salt.

14. The method of claim 12, wherein the step of separating the slurry further comprises the steps of:
using a primary separator to separate the slurry of ice, brine, ICL, and salt into an ice-brine slurry and a salt-ICL slurry;
separating the ice and a first volume of the brine from the ice-brine slurry;
separating the ICL and hydrohalites from the salt-ICL slurry; and
separating the salt and a second volume of the brine from the hydrohalites.

15. The method of claim 12, wherein the step of separating the slurry further comprises the steps of:
using a primary separator to separate the slurry of ice, brine, ICL, and salt into an ice-ICL slurry and a salt-brine slurry;
separating the ice and the ICL from the ice-ICL slurry; and
separating the salt and the brine from the salt-brine slurry.

16. The method of claim 1, wherein the step of melting the separated ice further comprises the steps of:
depositing the separated ice onto a conveyor belt;
conveying the separated ice under a wash array; and
depositing the washed ice into a melt tank.

17. A water treatment system for removing salt from a feed brine, the water treatment system comprising:
a crystallization tank configured to receive the feed brine;
a source of cooled intermediate-cold-liquid (ICL) connected to the crystallization tank, wherein the cooled ICL and feed brine are mixed within the crystallization tank to form a slurry of ice, brine, and ICL;
a primary separator configured to separate the slurry of ice, brine, and ICL; and
a melt tank configured to melt the separated ice to form a volume of desalinated liquid water.

18. The water treatment system of claim 17, wherein the crystallization tank is a concentric double-cylinder with an insulated annular space between the two cylinders.

19. The water treatment system of claim 17, wherein the primary separator is further configured to separate the slurry of ice, brine, and ICL into wet ice and an ICL-brine mixture.

20. The water treatment system of claim 19, further comprising a centrifuge configured to separate the ice and the brine from the wet ice.
